(19) United States
(12) Patent Application Publication
(10) Pub. No.: US 2014/0159419 A1
(43) Pub. Date: Jun. 12, 2014

(54) FLEXIBLE PANEL MEMBER FOR A TRAILER SIDE SKIRT SYSTEM

(71) Applicants: Leonard W. Baker, Lafayette, IN (US); James B. Brown, Crystal Lake, IL (US); Michael Courtney, Dayton, IN (US)

(72) Inventors: Leonard W. Baker, Lafayette, IN (US); James B. Brown, Crystal Lake, IL (US); Michael Courtney, Dayton, IN (US)

(21) Appl. No.: 14/100,071

(22) Filed: Dec. 9, 2013

Related U.S. Application Data
(60) Provisional application No. 61/735,689, filed on Dec. 11, 2012.
(60) Provisional application No. 61/735,965, filed on Dec. 11, 2012.

(51) Int. Cl. B62D 35/00

(52) U.S. Cl. CPC B62D 35/001
USPC 296/180.4

(57) ABSTRACT

A flexible panel member coupled to and along a bottom end of a side skirt panel of a trailer side skirt system includes (i) a first panel section defining a first side, a second side opposite the first side of the second panel section and an inner surface therebetween and (ii) a second panel section defining a first side, a second side opposite the first side of the second panel section and an inner surface therebetween. A connector of the flexible panel member is engaged with the first and second panel sections. The first and second panel sections are configured to move relative to each other and the connector is configured to slide relative to at least one of the first and second the second panel sections when the first and second panel sections move relative to each other.

This application claims priority under 35 U.S.C. §119(e) to U.S. Provisional Patent Application Ser. No. 61/735,689 filed Dec. 11, 2012 entitled FLEXIBLE PANEL MEMBER FOR A TRAILER SIDE SKIRT SYSTEM and to U.S. Provisional Patent Application Ser. No. 61/735,965 filed Dec. 11, 2012 entitled FLEXIBLE PANEL MEMBER FOR A TRAILER SIDE SKIRT SYSTEM, the entirety of each of which is hereby incorporated by reference herein.

### FIELD OF THE INVENTION

The present invention relates generally to semi-trailers such as van-type trailers, for example, and more specifically to aerodynamic side skirt systems for semi-trailers.

### BACKGROUND

Side skirt systems may be used on semi-trailers and/or other vehicles or trailers to reduce wind flow resistance and drag on the trailer and/or vehicle. Generally, side skirts extend downwardly from a bottom of, and along one or both sides of, the trailer and/or vehicle chassis toward the roadway at least partially along a length of the trailer and/or vehicle chassis.

Some side skirt systems may further or incorporate include a side protection device, or underride guard, in order to reduce the risk of passenger vehicles underriding the trailer. Such a side protection device is typically intended to reduce the extent to which a passenger vehicle can intrude under the side of a trailer, thereby diminishing passenger compartment intrusion.

In any case, some side skirt systems may further include or incorporate a flexible panel member which extends downwardly from one or more side skirt panels of the side skirt system toward the roadway. Such a flexible panel member may be designed aid in the reduction of wind flow resistance and drag and/or may be provided to absorb impacts and thereby protect the one or more side skirt panels from damage.

### SUMMARY

The present invention may comprise one or more of the features recited in the attached claims, and/or one or more of the following features and combinations thereof.

According to one aspect of the present disclosure, a flexible panel member coupled to and along a bottom end of a side skirt panel of a trailer side skirt system includes a first panel section defining a first side, a second side opposite the first side and an inner surface therebetween, with the first panel section defining at least one tab extending laterally away from the first side thereof, and a second panel section defining a first side, a second side opposite the first side of the second panel section and an inner surface therebetween, with the second panel section defining two or more tabs extending laterally away from the second side thereof. Illustratively, the at least one tab may be configured to be interlockingly received between the two or more tabs when the first side of the first panel section and the second side of the second panel section are brought together with the at least one tab in slidable contact with the inner surface of the second panel section and the at least two tabs in slidable contact with the inner surface of the first panel section.

Further illustratively, the at least one tab and the two or more tabs may each define a first flat portion adjacent to a corresponding one of the first and second panel sections, a second flat portion and a flexible corrugation between and connecting the first and second flat portions. The flexible panel member may further comprise means for affixing the second flat portion of the at least one tab to the inner surface of the second panel section, and/or may further comprise means for affixing the second flat portion of each of the two or more tabs to the inner surface of the first panel section.

According to another aspect of the present disclosure, a flexible panel member coupled to and along a bottom end of a side skirt panel of a trailer side skirt system includes a first panel section defining a first side, a second side opposite the first side and an inner surface therebetween, the first panel section defining at least one tab extending laterally away from the first side thereof, the at least one tab defining a first flat portion adjacent to the first side, a second flat portion and a flexible corrugation between and connecting the first and second flat portions, a second panel section defining a first side, a second side opposite the first side of the second panel section and an inner surface therebetween, the first and second flat portions of the at least one tab contacting the inner surface of the second panel section when the first side of the first panel section and the second side of the second panel section are brought together, and means for affixing the second flat portion of the at least one tab to the inner surface of the second panel section. Illustratively, the flexible corrugation may comprise a first flexible corrugation and a second flexible corrugation positioned beside the first flexible corrugation.

According to still another aspect of the present disclosure, a flexible panel member coupled to and along a bottom end of a side skirt panel of a trailer side skirt system includes a plurality of panel sections each defining a first side, a second side opposite the first side and an inner surface therebetween, and each further defining a plurality of connector rails affixed to or integral with the inner surface, each of the plurality of connector rails defining an elongated channel therein having a longitudinal axis extending between the first and second sides of the panel section, each of the plurality of elongated channels of one of the plurality of panel sections aligned with a corresponding one of the plurality of elongated channels of another of the plurality of panel sections when the panes are positioned side-by-side, and one of a connector element and a connector blade or plate positioned at least partially within and retained by one of the plurality of elongated channels of a first one of the plurality of panel sections and a corresponding one of the plurality of elongated channels of a second one of the plurality of panel sections positioned side-by-side with the first one of the plurality of panel sections.

According to yet another aspect of the present disclosure, a flexible panel member coupled to and along a bottom end of a side skirt panel of a trailer side skirt system includes a plurality of panel sections each defining a first side, a second side opposite the first side and an inner surface therebetween. Each panel section may further define at least one tab extending laterally away from one of the first side and the second side and at least one corresponding slot at or adjacent to the other of the first side and the second side. The at least one tab and the at least one corresponding slot may be sized and positioned relative to each of the plurality of panel sections such that the at least one tab of each of the plurality of panel sections is slidably received within the slot of an adjacent one of the plurality of panel sections when each of the plurality of panels are positioned side-by-side. Illustratively, the slot of each of the plurality of panel sections may be defined between the inner surface of each of the plurality of panel sections and a housing cover positioned over and coupled to the inner surface of each of the plurality of panel sections.

According to still another aspect of the present disclosure, a flexible panel member coupled to and along a bottom end of a side skirt panel of a trailer side skirt system includes a first panel section defining a first side, a second side opposite the first side, and an inner surface therebetween. The flexible panel member further includes a second panel section defining a first side, a second side opposite the first side, and an inner surface therebetween. A tab of the flexible panel member extends laterally away from the first side of the first panel section, and a slot of the flexible panel member is adjacent the second side of the second panel section. The slot is sized and positioned to slidably receive the tab therein when the first and second panel sections are positioned adjacent each other.

In one illustrative embodiment, the tab may be coupled to the first panel section by a rivet, screw, staple, and/or adhesive.

In another illustrative embodiment, the flexible panel member may also include a housing having a first rail coupled to the inner surface of the second panel section, a second rail spaced-apart from the first rail and coupled to the inner surface of the second panel section, and a housing cover positioned over the inner surface of the second panel section and coupled to each of the first and second rails to define the slot between the inner surface of the second panel section and the housing cover. Illustratively, the housing may be coterminous with the second side of the second panel section.

In still another illustrative embodiment, the flexible panel member may also include (i) a second tab extending laterally away from the second side of the first panel section and (ii) a second slot adjacent the first side of the second panel section.

In yet another illustrative embodiment, the flexible panel member may also include (i) a second tab extending laterally away from the first side of the second panel section and (ii) a second slot adjacent the second side of the first panel section.

In still another illustrative embodiment, the tab may be configured to move relative to the slot so that each of the first and second panel sections may be movable relative to each other in a direction parallel to a longitudinal axis of the flexible panel member.

In yet another illustrative embodiment, the tab may be integral with the first panel section and the slot may be integral with the second panel section.

In still another illustrative embodiment, the flexible panel member may also include a third panel section defining a first side, a second side opposite the first side, and an inner surface therebetween. Illustratively, the second panel section may include a second tab extending laterally away from the first side of the second panel section. Further illustratively, the third panel section may include a second slot adjacent the second side of the third panel section and the second tab may be slidably received within the second slot.

According to still another aspect of the present disclosure, a flexible panel member coupled to and along a bottom end of a side skirt panel of a trailer side skirt system includes (i) a first panel section defining a first side, a second side opposite the first side of the second panel section and an inner surface therebetween and (ii) a second panel section defining a first side, a second side opposite the first side of the second panel section and an inner surface therebetween. A connector of the flexible panel member is engaged with the first and second panel sections. Illustratively, the first and second panel sections are configured to move relative to each other and the connector is configured to slide relative to at least one of the first and second the second panel sections when the first and second panel sections move relative to each other.

In one illustrative embodiment, the connector may be a first tab coupled to and extending laterally away from the first side of the first panel section. Illustratively, the second panel section may include two second tabs coupled to and extending laterally away from the second side of the second panel section. Further illustratively, the first tab may be configured to be interlockingly received between the two second tabs when the first side of the first panel section and the second side of the second panel section are adjacent each other. The first tab may be in slidable contact with the inner surface of the second panel section and the two second tabs may each be in slidable contact with the inner surface of the first panel section. Further illustratively, the first tab and the two second tabs may each define a first flat portion adjacent to a corresponding one of the first and second panel sections, a second flat portion, and a flexible corrugation between and connecting the first and second flat portions. Illustratively, the second flat portion of the first tab may be coupled to the second panel section, and the second flat portion of each of the two second tabs may be coupled to the first panel section.

In another illustrative embodiment, the connector may be a tab extending laterally away from the first side of the first panel section. The second panel section may include a slot configured to slidably receive the tab therein. Illustratively, the flexible panel member may also include a second tab extending laterally away from the second side of the first panel section. The second panel section may also include a second slot. Further illustratively, the flexible panel member may also include a housing coupled to the inner surface of the second panel section. The housing may include a housing cover positioned over the inner surface of the second panel section to define the slot between the inner surface of the second panel section and the housing cover.

In still another illustrative embodiment, the connector may be a flexible rod. Illustratively, the first panel section may include a first connector rail defining a first channel and the second panel section may include a second connector rail defining a second channel aligned with the first channel when the first and second panels are positioned side-by-side. The connector may be slidably received within the first and second channels.

### BRIEF DESCRIPTION OF THE DRAWINGS

FIG. 1 is a perspective view of a trailer and an aerodynamic side skirt system coupled to the trailer generally between the rear wheels and the front support of the trailer.

FIG. 2 is a perspective view of a portion of one of the aerodynamic side skirt systems coupled to the trailer of FIG. 1.

FIG. 3 is a perspective view of an embodiment of a flexible panel member forming part of the aerodynamic side skirt system illustrated in FIGS. 1 and 2.

FIG. 4 is a perspective and partially exploded view of an alternate embodiment of the flexible panel member illustrated in FIG. 3.

FIG. 5 is a perspective and partially exploded view of another alternate embodiment of the flexible panel member illustrated in FIG. 3.

FIG. 6 is a perspective and partially exploded view of yet another alternate embodiment of the flexible panel member illustrated in FIG. 3.

FIG. 7 is a perspective view of another embodiment of a flexible panel member forming part of the aerodynamic side skirt system illustrated in FIGS. 1 and 2.

FIG. 8A is a perspective and partial exploded view of the flexible panel member illustrated in FIG. 7 showing one flexible panel section attachment mechanism.

FIG. 8B is a perspective view of the flexible panel member illustrated in FIG. 7 showing a number of alternate flexible panel section attachment mechanisms.

FIG. 9 is a perspective view of one flexible panel section of an alternate embodiment of the flexible panel member illustrated in FIG. 7.

FIG. 10 is a perspective and exploded view of yet another embodiment of a flexible panel member forming part of the aerodynamic side skirt system illustrated in FIGS. 1 and 2.

FIG. 11 is a perspective and partially exploded view of an alternate embodiment of the flexible panel member illustrated in FIG. 10.

FIG. 12 is a perspective and partially exploded view of still another alternate embodiment of a flexible panel member forming part of the aerodynamic side skirt system illustrated in FIGS. 1 and 2.

FIG. 13 is a side view of the embodiment illustrated in FIG. 12 showing details of the flexible panel section coupling structure.

FIG. 14A is a perspective view of an embodiment of the flexible panel section coupling member illustrated in FIG. 13.

FIG. 14B is an end view of the flexible panel section coupling member illustrated in FIG. 14A.

FIG. 15A is a perspective view of an alternate embodiment of the flexible panel section coupling member illustrated in FIG. 13.

FIG. 15B is an end view of the flexible panel section coupling member illustrated in FIG. 15A.

FIG. 16A is a perspective view of another alternate embodiment of the flexible panel section coupling member illustrated in FIG. 13.

FIG. 16B is an end view of the flexible panel section coupling member illustrated in FIG. 16A.

FIG. 17A is a perspective view of yet another alternate embodiment of the flexible panel section coupling member illustrated in FIG. 13.

FIG. 17B is an end view of the flexible panel section coupling member illustrated in FIG. 17A.

FIG. 18A is a perspective view of still another embodiment of the flexible panel section coupling member illustrated in FIG. 13.

FIG. 18B is an end view of the flexible panel section coupling member illustrated in FIG. 18A.

FIG. 19A is a perspective view of a further alternate embodiment of the flexible panel section coupling member illustrated in FIG. 13.

FIG. 19B is an end view of the flexible panel section coupling member illustrated in FIG. 19A.

FIG. 20A is a perspective view of yet a further alternate embodiment of the flexible panel section coupling member illustrated in FIG. 13.

FIG. 20B is an end view of the flexible panel section coupling member illustrated in FIG. 20A.

FIG. 21A is a perspective view of still a further alternate embodiment of the flexible panel section coupling member illustrated in FIG. 13.

FIG. 21B is an end view of the flexible panel section coupling member illustrated in FIG. 21A.

FIG. 22A is a perspective view of yet another alternate embodiment of the flexible panel section coupling member illustrated in FIG. 13.

FIG. 22B is an end view of the flexible panel section coupling member illustrated in FIG. 22A.

FIG. 23A is a perspective view of still another alternate embodiment of the flexible panel section coupling member illustrated in FIG. 13.

FIG. 23B is an end view of the flexible panel section coupling member illustrated in FIG. 23A.

FIG. 24A is a perspective view of still a further embodiment of the flexible panel section coupling member illustrated in FIG. 13.

FIG. 24B is an end view of the flexible panel section coupling member illustrated in FIG. 24A.

FIG. 25 is a perspective and partially exploded view of a further alternate embodiment of a flexible panel member forming part of the aerodynamic side skirt system illustrated in FIGS. 1 and 2.

FIG. 26 is a plan and partially exploded view of yet a further alternate embodiment of a flexible panel member forming part of the aerodynamic side skirt system illustrated in FIGS. 1 and 2.

FIG. 27 is a perspective view of one of the flexible panel sections illustrated in FIG. 26 showing details of the slot defined on the inner surface of the panel flexible panel section.

FIG. 28 is a plan view of the embodiment illustrated in FIGS. 26 and 27 showing the tab defined on the inner surface of one flexible panel section received within the slot defined on the adjacent flexible panel section.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

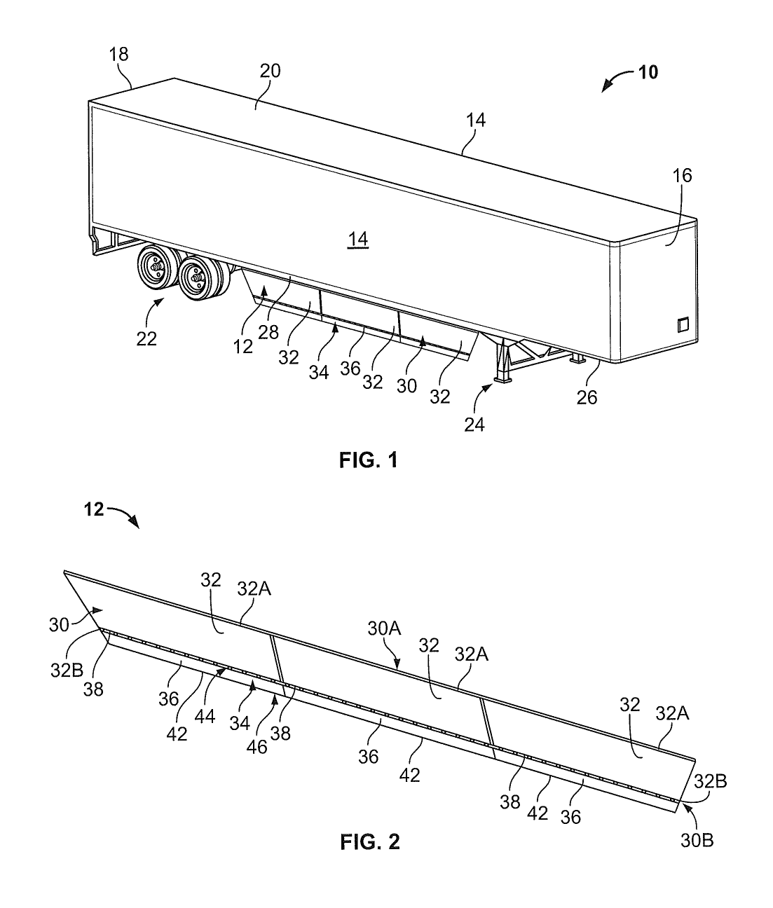

Referring to FIGS. 1 and 2, a trailer 10 is shown having an aerodynamic side skirt system 12 coupled thereto and extending downwardly from each side wall 14 of the trailer 10. Illustratively, the side skirt system 12 operates to improve the aerodynamic efficiency of the trailer 10 by reducing drag and wind flow under the trailer 10 while the trailer 10 is traveling down the road. Illustratively, the side skirt system 12 extends below the side wall 14 of the trailer 10 at least partially along a length of the trailer 10. In the illustrated embodiment, for example, the side skirt system 12 extends generally between the landing gear 24 and the rear wheel assembly 22 of the trailer 10. However, it will be understood that the side skirt system 10 may alternatively be sized to extend along a greater or a lesser length of the trailer 10 than what is illustratively shown in the figures.

As shown in FIG. 1, the trailer 10 includes side walls 14, a front end wall 16, a rear end wall 18, and a roof 20 defining an inside storage portion (not shown) suitable for storing and/or transporting various articles or good. The trailer 10 further includes a rear wheel assembly 22 and a front support or landing gear 24 each coupled to a bottom wall or floor assembly 26 of the trailer 10. Illustratively, the floor assembly 26 of the trailer 10 includes right and left base rails 28 extending along a length of the trailer 10. The front end of the trailer 10, e.g., forward of the landing gear 24, is illustratively configured to be coupled to a tractor (not shown) for towing the trailer 10 thereon, thus providing a tractor-trailer assembly. It should be understood that while the aerodynamic side skirt system 12 is shown for use with a trailer 10, the side skirt system 12 may alternatively be coupled to any vehicle to reduce the drag thereon. As shown in FIG. 1, the side skirt system 12 is generally coupled to the floor assembly 26 of the trailer 10, and extends downwardly from the base rail 28 of the trailer.

Illustratively, the trailer 10 includes two aerodynamic skirt systems 12; one each coupled to an opposite side of the floor assembly 26 of the trailer 10 to extend downwardly from the floor assembly 26 generally parallel to the corresponding side wall 14 of the trailer 10. In the embodiment illustrated in FIGS. 1 and 2, the side skirt system 12 includes a side skirt wall 30 having three wall panels 32 coupled to each other in a conventional manner. It will be understood, however, that the side skirt system 12 may alternatively include more or fewer wall panels 32 such that the side skirt wall 30 may generally include one or multiple wall panels 32. As shown in FIG. 2, each wall panel 32 includes a top edge or end 32A that is coupled or mounted to the floor assembly 26 of the trailer 10 in a conventional manner, and a bottom edge or end 32B opposite to the top edge or end 32A. The top edge or end 32A of the one or more wall panels 32 define a top end or edge 30A of the side skirt wall 30, and the bottom edge or end 32B of the one or more wall panels 32 define a bottom end or edge 30B of the side skirt wall 30.

In one embodiment, each of the one or more wall panels 32 is made of a composite material. For example, the composite material may include a plastic core and metal outer skins coupled to the plastic core. Such a composite material provides a rigid, but lightweight and durable material. In one illustrative embodiment, for example, each of the one or more wall panels 32 may be made of a DURAPLATE® composite panel provided by Wabash National Corporation of Lafayette, Ind. DURAPLATE® composite panels are constructed of a high-density polyethylene plastic core bonded between two high-strength steel skins. It should be understood that other suitable composite materials may be alternatively or additionally used. In alternate embodiments, at least one of the wall panels 32 may be formed of any suitable, non-composite materials such as metals, metal alloys, and/or plastics, for example.

As shown in FIGS. 1 and 2, the side skirt system 12 further includes a flexible panel member 34 coupled to the bottom end or edge 30B of the of the side skirt wall 30. In one embodiment, the flexible panel member 34 is made of a plastic material such as polyvinyl chloride (PVC), however, the flexible panel member 34 may alternatively or additionally be formed of one or more other suitable materials. In some embodiments, the flexible wall member 34 may be configured to resist airflow and/or to prevent damage to the side skirt wall 30 from forces applied upwardly and/or laterally to the bottom of the side skirt system 12. In such instances, for example, the flexible wall member 34 is configured to bend, or flex to prevent damage to the side skirt wall 30.

The flexible panel member 34 may include any number of flexible panel sections, and in the example embodiment illustrated in FIGS. 1 and 2 the flexible panel member 34 includes three such flexible panel sections 36 positioned side-by-side. It will be understood, however, that the flexible panel member 34 may alternatively include more or fewer flexible panel sections 36 positioned side-by-side such that the flexible panel member 34 may generally include one or multiple flexible panel sections. As shown in FIG. 2, each flexible panel section 36 includes a top edge or end 38 that is coupled or mounted to the bottom end or edge of the side skirt wall 30, and a bottom edge or end 42 opposite to the top edge or end 38. The top edge or end 38 of the one or more flexible panel sections 36 define a top end or edge 44 of the flexible panel member 34, and the bottom edge or end 42 of the one or more flexible panel sections 36 define a bottom end or edge 46 of the flexible panel member 34.

As illustrated in FIG. 2, the top edge or end 44 of the flexible panel member 34 is attached or mounted to the bottom edge or end of the side skirt wall 30 by a plurality of conventional fixation members, e.g., screws, rivets, nut/bolt combinations or the like, although it will be understood that the top edge or end 44 of the flexible panel member 34 may be alternatively or additionally attached or mounted to the bottom edge or end of the side skirt wall 30 using one or more other conventional attachment or mounting mechanisms, e.g., adhesive or one or more other bonding media, conventional clamping structure(s) or the like. The side skirt wall 30 in the illustrated embodiment illustratively makes up approximately 70% of the total height of the side skirt system 12 while the flexible panel member 34 makes up approximately the lower 30% of the total height of the side skirt system 12. It will be understood, however, that in alternate embodiments the side skirt wall 30 and the flexible panel member 34 may each make up other percentages of the total height of the side skirt system 12.

In the embodiment illustrated in FIGS. 1 and 2 in which the side skirt wall 30 includes three wall panels 32 and the flexible panel member 34 includes three flexible panel sections 36, the flexible panel sections 36 are sized such that the opposite ends of each section 36 are coterminous with opposite ends of a corresponding wall panel 32 such that each flexible panel section 36 is juxtaposed under a corresponding wall panel 32. In alternative embodiments in which the number of flexible panel sections 36 is equal to the number of wall panels 32, the opposite ends of the flexible panel sections 36 need not be coterminous with the opposing ends of corresponding ones of the wall panels. In other alternative embodiments in which the number of flexible panel members 34 is different than the number of wall panels 32, an end of any of the one or more flexible panel sections 36 may, but need not, be coterminous with an end of one of the one or more wall panels 32.

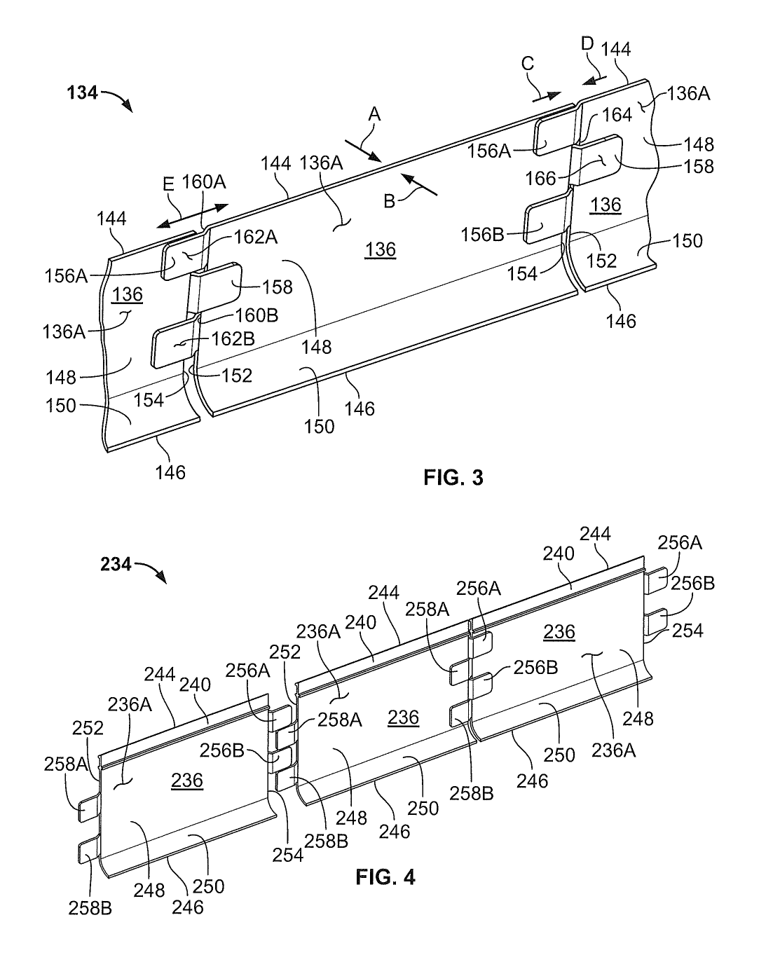

Referring now to FIG. 3, a perspective view of one embodiment 134 of the flexible panel member 34 forming part of the aerodynamic side skirt system 12 illustrated in FIGS. 1 and 2 is shown. The flexible panel member 134 is illustratively made up of a plurality of flexible panel sections 136, and one full and two partial flexible panel sections 136 are illustrated in FIG. 3. In the illustrated embodiment, each of the plurality of flexible panel sections 136 includes a top section 148 which terminates at a top edge or end 144 of the flexible panel section 136, and a bottom section 150 extending downwardly away from the top section 148 and which terminates at a bottom edge or end 146 of the flexible panel section 136. Each of the plurality of flexible panel sections 136 further defines one side 152 and an opposite side 154 with the top and bottoms sections 148 and 150 extending laterally between the two opposing sides 152, 154.

Two tabs 156A and 156B extend laterally away from one side 152 of each flexible panel section 136, and a single tab 158 extends laterally away from the opposite side 154 of each flexible panel section 136 such that the tabs 156A, 156B and 158 generally extend parallel to a longitudinal axis (e.g., illustrated by the arrow E) of the flexible panel member 134. The tabs 156A and 156B each define a curved or angled portion 160A, 160B respectively, adjacent to the side 152 of the flexible panel section 136, and a flat portion 162A, 162B respectively, which extends from the curved or angled portion 160A, 160B in a direction laterally away from the side 152 of the flexible panel section 136. The tab 158 likewise defines a curved or angled portion 164 adjacent to the side 154 of the flexible panel section 136, and a flat portion 166 which extends from the curved or angled portion 164 in a direction laterally away from the side 154 of the flexible panel section 136.

The tabs 156A, 156B and 158 are positioned relative to the sides 152 and 154 respectively of the flexible panel sections 136 such that the tab 158 extends between the tabs 156A and 156B when opposing ends 152 and 154 of two adjacent flexible panel sections 136 are brought together as illustrated in FIG. 3. As also illustrated in FIG. 3, the curved or angled sections 160A, 160B, 164 are configured such that the tabs 156A and 156B extend over and in contact with, e.g., in sliding engagement with, the inner surface 136A of the adjacent flexible panel section 136, and the tab 158 likewise extends over and in contact with, e.g., in sliding engagement with, the inner surface 136A of the adjacent flexible panel section 136. The tabs 156A, 156B and 158 thus interlock with each other in a manner that aligns the plurality of flexible panel sections 136 transversely (e.g., illustrated by the arrows A and B) such that the plurality of flexible panel sections 136 all lie substantially along a common line that is, or is parallel with, the longitudinal axis defined by the flexible panel member 134. The sliding engagement of the tabs 156A, 156B and 158 relative to adjacent ones of the flexible panel sections 136 allow each of the flexible panels 136 to move toward one adjacent panel section 136 (e.g., as shown by arrows C and D) while moving away from the panel section 136 at its opposite side (e.g., as shown by arrow E). Each of the plurality of flexible panel sections 136 may thus expand away from and/or contract toward adjacent flexible panel sections 136 making up the flexible panel member 134. Such relative movement between the flexible panel sections 136 illustratively reduces or eliminates bond wear between adjacent panel sections 136 that may otherwise be rigidly attached to each other.

Referring now to FIG. 4, an alternate embodiment 234 of the flexible panel member 134 illustrated in FIG. 3 is shown. Many of the features and components of the embodiment 234 illustrated in FIG. 4 are identical to those illustrated in FIG. 3, and like features and components are illustrated in FIG. 4 with like numbers offset by a factor of 100. In the illustrated embodiment, each of the plurality of flexible panel sections 236 includes a top section 240 which terminates at a top edge or end 244 of the flexible panel section 236, a bottom section 250 which terminates at a bottom edge or end 246 of the flexible panel section 236 and a middle section 248 which extends between the top and bottom sections 240 and 250 respectively. Otherwise, the embodiment 234 illustrated in FIG. 4 differs from that illustrated in FIG. 3 primarily in the number and configuration of the tabs. More specifically, each of the flexible panel sections 236 in the embodiment illustrated in FIG. 4 includes a pair of tabs 256A, 256B extending laterally away from one side 254, and a pair of tabs 258A, 258B extending laterally away from the opposite side 252. The tabs 256A, 256B, 258A, 258B are positioned such that the tab 258A extends between the tabs 256A and 256B, and the tab 258B extends below the tab 256B with the tabs 256A, 256B, 258A, 258B interlocking as described above. Each of the tabs 256A, 256B, 258A, 258B are configured to slidingly engage the inner surfaces 236A of adjacent ones of the flexible panel sections 236 as also described above.

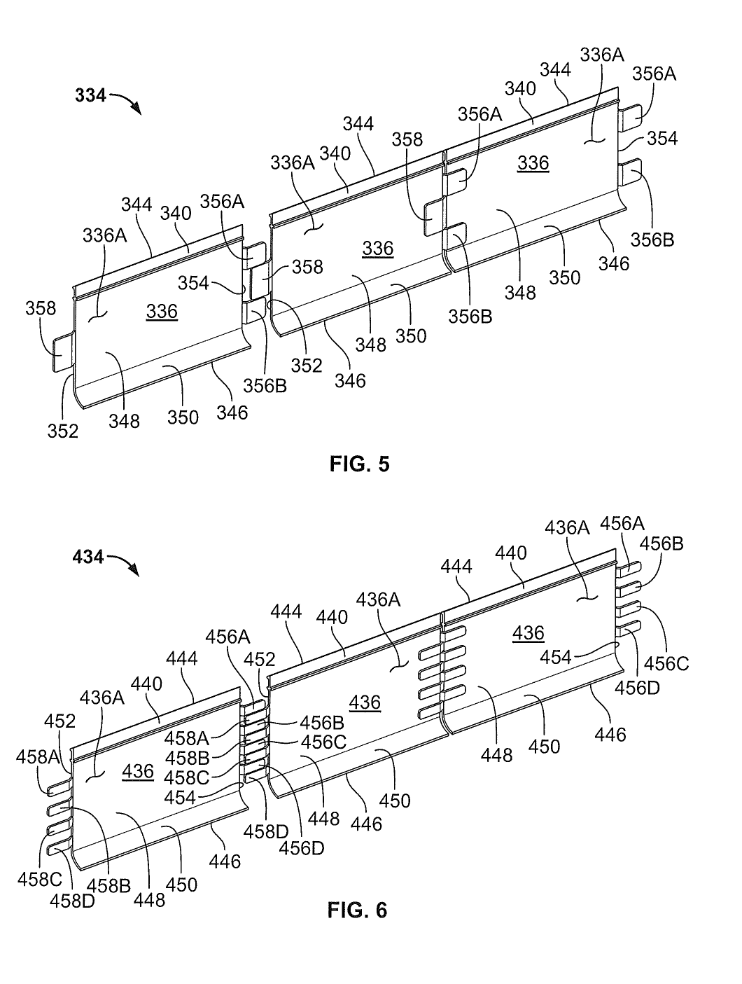

Referring now to FIG. 5, another alternate embodiment 334 of the flexible panel member 134 illustrated in FIG. 3 is shown. Many of the features and components of the embodiment 334 illustrated in FIG. 5 are identical to those illustrated in FIG. 3, and like features and components are illustrated in FIG. 5 with like numbers offset by a factor of 200. In the illustrated embodiment, each of the plurality of flexible panel sections 336 includes a top section 340 which terminates at a top edge or end 344 of the flexible panel section 336, a bottom section 350 which terminates at a bottom edge or end 346 of the flexible panel section 336 and a middle section 348 which extends between the top and bottom sections 340 and 350 respectively. Otherwise, the embodiment 334 illustrated in FIG. 5 differs from that illustrated in FIG. 3 primarily in the number and configuration of the tabs. More specifically, each of the flexible panel sections 236 in the embodiment illustrated in FIG. 4 includes a pair of tabs 356A, 356B extending laterally away from one side 354, and tab 358 extending laterally away from the opposite side 352. The tabs 356A, 356B and 358 interlock in the same manner as described above with respect FIG. 3 when opposing sides 352 and 354 of adjacent flexible panel sections 336 are brought together. Each of the tabs 356A, 356B and 358 are configured to slidingly engage the inner surfaces 336A of adjacent ones of the flexible panel sections 336 as also described above.

Referring now to FIG. 6, yet another alternate embodiment 434 of the flexible panel member 134 illustrated in FIG. 3 is shown. Many of the features and components of the embodiment 434 illustrated in FIG. 6 are identical to those illustrated in FIG. 3, and like features and components are illustrated in FIG. 6 with like numbers offset by a factor of 300. In the illustrated embodiment, each of the plurality of flexible panel sections 436 includes a top section 440 which terminates at a top edge or end 444 of the flexible panel section 436, a bottom section 450 which terminates at a bottom edge or end 446 of the flexible panel section 436 and a middle section 448 which extends between the top and bottom sections 440 and 450 respectively. Otherwise, the embodiment 434 illustrated in FIG. 6 differs from that illustrated in FIG. 3 primarily in the number and configuration of the tabs. More specifically, each of the flexible panel sections 436 in the embodiment illustrated in FIG. 6 includes four tabs 456A, 456B, 456C and 456D extending laterally away from one side 454, and four tabs 458A, 458B, 458C and 458D extending laterally away from the opposite side 452. The tabs 456A, 456B, 456C and 456D, and the tabs 458A, 458B, 458C and 458D are positioned such that the tabs 458A, 458B and 458C extend between the tabs 456A and 456B, 455B and 456C, and 456C and 456D respectively, with the tab 456A extending above the tab 458A and the tab 458D extending below the tab 456D, with the tabs 456A, 456B, 456C and 456D interlocking with the tabs 458A, 458B, 458C and 458D as described above. Each of the tabs 456A, 456B, 456C and 456D interlocking with the tabs 458A, 458B, 458C and 458D are further configured to slidingly engage the inner surfaces 436A of adjacent ones of the flexible panel sections 436 as also described above.

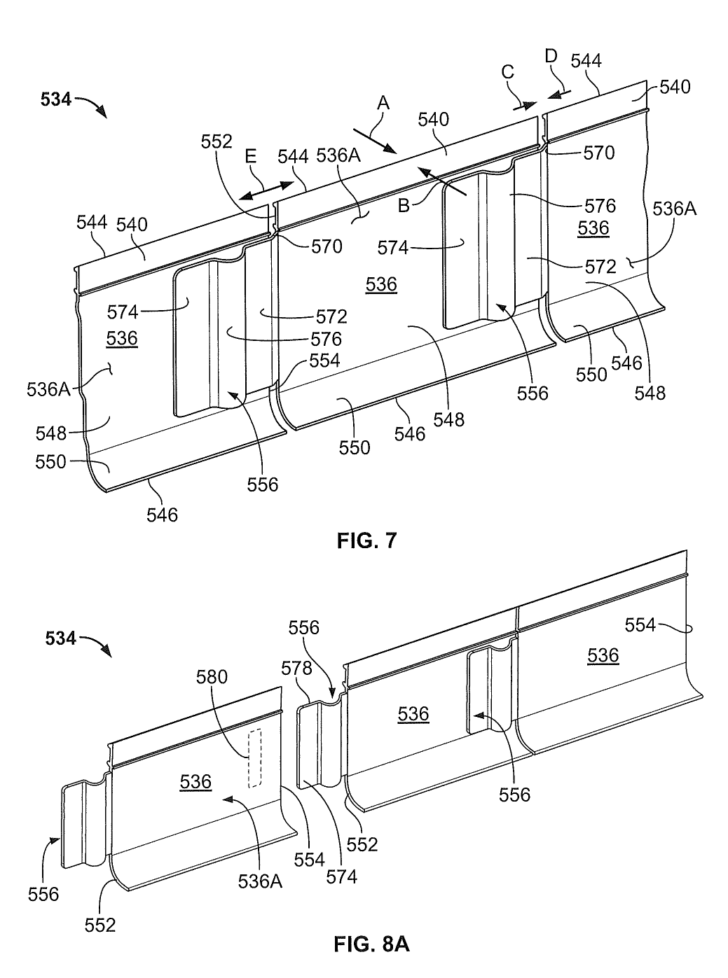

Referring now to FIG. 7, another embodiment 534 of the flexible panel member 34 forming part of the aerodynamic side skirt system 12 illustrated in FIGS. 1 and 2 is shown. The flexible panel member 534 is illustratively made up of a plurality of flexible panel sections 536, and one full and two partial flexible panel sections 536 are illustrated in FIG. 7. In the illustrated embodiment, each of the plurality of flexible panel sections 536 includes a top section 540 which terminates at a top edge or end 144 of the flexible panel section 136, a bottom section 450 which terminates at a bottom edge or end 546 of the flexible panel section 536 and a middle section 548 which extends between the top and bottom sections 540 and 550 respectively. Each of the plurality of flexible panel sections 536 further defines one side 552 and an opposite side 554 with the top, middle and bottoms sections 540, 548 and 550 respectively extending laterally between the two opposing sides 552, 554. A single tab 556 extends laterally away from one side 552 of each panel section 536 such that the tab 556 generally extends parallel to a longitudinal axis (e.g., illustrated by the arrow E) of the flexible panel member 534.

In the illustrated embodiment, the tab 556 is sized such that is substantially spans the middle panel section 548, although in alternate embodiments the tab 556 may be sized smaller or larger than that illustrated in FIG. 7. In any case, the tab 556 defines a curved or angled portion 570 adjacent to the side 552 of the flexible panel section 536, a flat portion 572 which extends from the curved or angled portion 570 in a direction laterally away from the side 552 of the flexible panel section 536, another flat portion 574 which extends laterally away from the side 552 of the flexible panel section 536 and a raised portion or corrugation 576 between and connecting the two flat portions 572 and 574. The curved or angled portion 570 is configured such that the flat portions 572, 574 and the corrugated portion 576 all extend over the inner surface 536A of the adjacent flexible panel section 536, with the flat portions 572 and 574 in contact with the inner surface 536A, when opposing ends 552, 554 of two adjacent panel sections 536 are brought together as illustrated in FIG. 7.

In the illustrated embodiment, the inner surface of the flat portion 574 is affixed to the inner surface 536A of the flexible panel section 536, and the flat portion 572 is in movable contact with, e.g., in sliding engagement with, the inner surface 536A of the adjacent flexible panel section 536. This engagement arrangement movably interlocks each of the flexible panel sections 536 together in a manner that aligns the plurality of panel sections 536 transversely (e.g., illustrated by the arrows A and B) such that the plurality of panel sections 536 all lie substantially along a common line that is, or is parallel with, the longitudinal axis defined by the flexible panel member 534. The combination of the flexible corrugated portions 576 and the sliding engagement of the flat portions 572 of the tabs 556 relative to adjacent ones of the flexible panel sections 536 allows each of the flexible panel sections 536 to move toward one adjacent panel section 536 (e.g., as shown by arrows C and D) while moving away from the panel section 536 at its opposite side (e.g., as shown by arrow E), and vice versa. Each of the plurality of flexible panel sections 536 may thus expand away from and/or contract toward adjacent flexible panel sections 536 making up the flexible panel member 534.

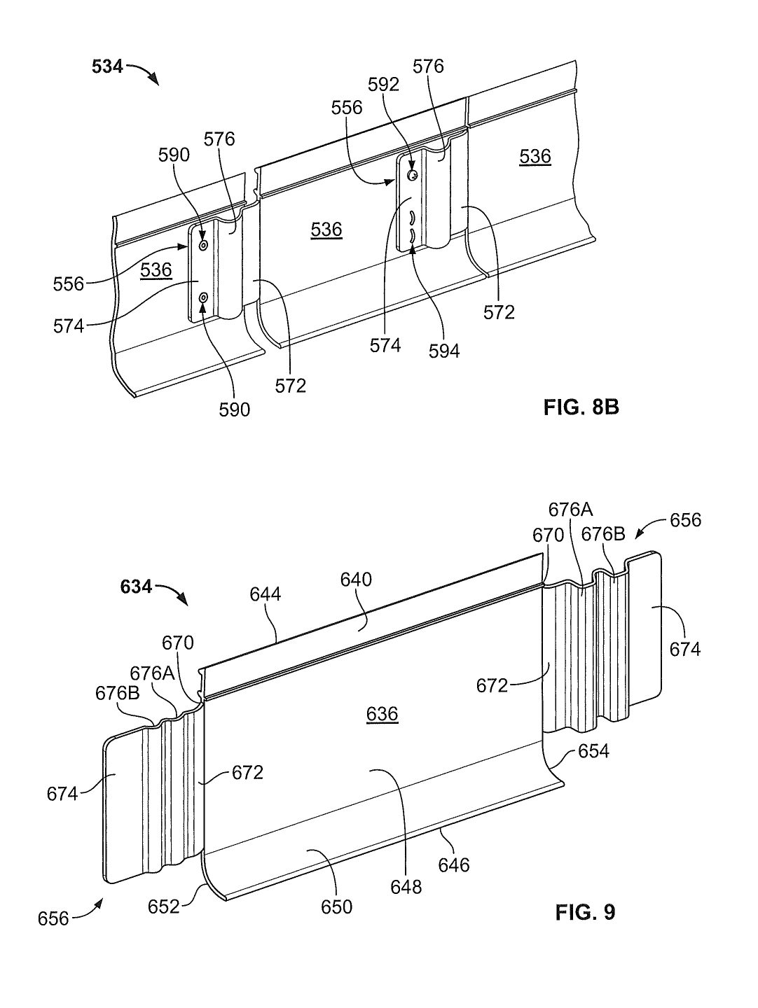

Referring now to FIG. 8A, the flexible panel member 534 illustrated in FIG. 7 is shown illustrating one flexible panel section attachment mechanism. In the illustrated embodiment, a conventional adhesive or other conventional bonding medium 580 is selectively applied to a portion of the inner surface of the flexible panel section 536 or to at least a portion of the inner surface 578 of the flat portion 574 of the tab 556, and the flat portion 574 is affixed thereby to the inner surface 536A of the flexible panel section 536. Referring to FIG. 8B, the flexible panel member 534 illustrated in FIG. 7 is shown illustrating a number of alternate flexible panel section attachment mechanisms. For example, in one alternate embodiment, the flat portion 574 of one or more tabs 556 may be affixed to the inner surface 536A of the flexible panel section 536 with one or more conventional rivets 590. Alternatively or additionally, the flat portion 574 of one or more tabs 556 may be affixed to the inner surface 536A of the flexible panel section 536 with one or more conventional rivets screws 592. Alternatively or additionally still, the flat portion 574 of one or more tabs 556 may be affixed to the inner surface 536A of the flexible panel section 536 with one or more conventional rivets screws 594. Those skilled in the art will recognize other attachment mechanisms that may be used to affix the flat portion 574 of one or more of the tabs 556 to the inner surface 536A of the flexible panel section 536, and it will be understood that any such other attachment mechanisms are contemplated by this disclosure. It is further understood that is within the scope of this disclosure to affix portions of the tabs of all of the various embodiments disclosed herein by the above-referenced attachment mechanisms.

Referring now to FIG. 9, an alternate embodiment 634 of the flexible panel member 534 illustrated in FIG. 7 is shown. Many of the features and components of the embodiment 634 illustrated in FIG. 9 are identical to those illustrated in FIG. 7, and like features and components are illustrated in FIG. 9 with like numbers offset by a factor of 100. In the illustrated embodiment, each flexible panel section 636 may include a tab 656 extending laterally away from one side 652 or the other 654 of the flexible panel section 636. Although two such tabs 656 are shown in FIG. 9, it will be understood that the flexible panel section 536 will actually include only one of the tabs 656, e.g., either that extending laterally away from the side 652 or the side 654 of the flexible panel member 636, and the additional tab 656 illustrated in FIG. 9 is included only for the purpose of demonstrating the action of the tab 656 during lateral movement thereof. Otherwise, the embodiment 634 illustrated in FIG. 9 differs from that illustrated in FIG. 7 primarily in the configuration of the tab 656. More specifically, the tab 656 includes the curved or angled portion 670 and the two flat portions 672, 674 as described above with respect to FIG. 7, but unlike the tab 556 the tab 656 includes two corrugations 676A and 676B between the flat portions 672 and 674. The flat portion 672 is connected to the corrugation 676A, the corrugation 676A is connected to the corrugation 676B, and the corrugation 676B is connected to the flat portion 674. The embodiment 634 operates as described with respect to FIG. 7, except that in the embodiment illustrated in FIG. 9 the additional corrugation 676B provides for additional lateral movement of the flexible panel sections 636 relative to each other. It will be understood that in other alternate embodiments, one or more of the tabs extending laterally from one or more of the flexible panel sections 636 may include any number of corrugations.

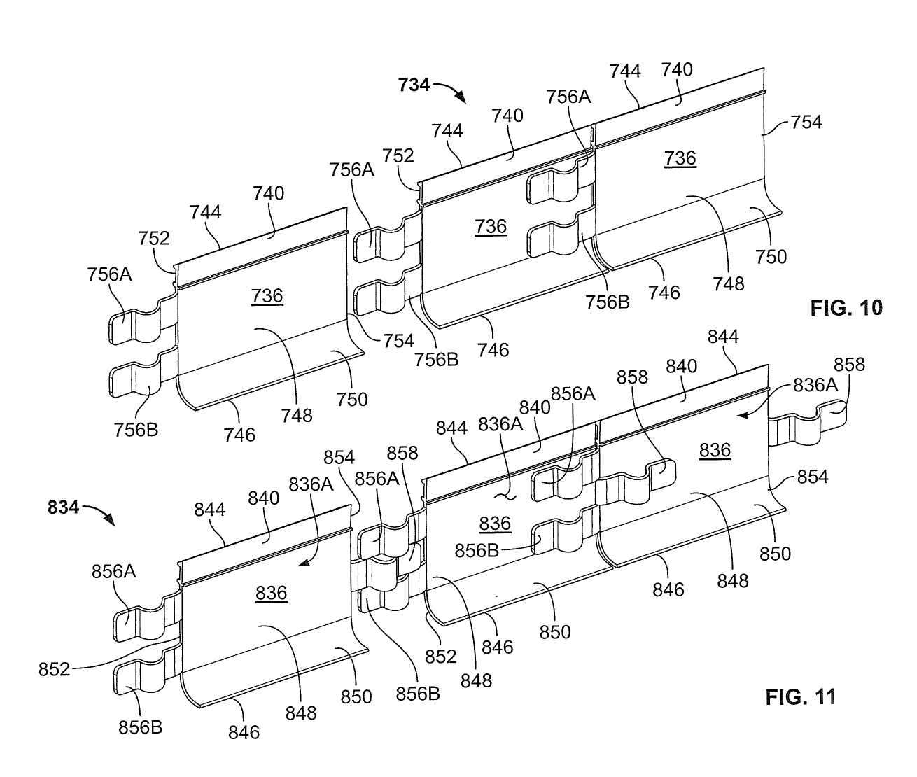

Referring now to FIG. 10, another alternate embodiment 734 of the flexible panel member 534 illustrated in FIG. 7 is shown. Many of the features and components of the embodiment 734 illustrated in FIG. 10 are identical to those illustrated in FIG. 7, and like features and components are illustrated in FIG. 10 with like numbers offset by a factor of 200. The embodiment 734 illustrated in FIG. 10 differs from that illustrated in FIG. 7 primarily in that each flexible panel section 736 includes a pair of tabs 756A and 756B extending laterally away from one side 752 or the other 754 of the flexible panel section 736, wherein each tab 756A and 756B is identical in structure, but not in size, to the tab 556 illustrated and described with respect to FIG. 7. The tabs 756A and 756B are sized such that the tab 756A is juxtaposed over the tab 756B as illustrated in FIG. 10. The embodiment 734 operates as described with respect to FIG. 7. It will be understood that other alternate embodiments may include any number of tabs 756, and one or more of any such number of tabs 756 may include any number of corrugations.

Referring now to FIG. 11, yet another embodiment 834 of the flexible panel member 34 forming part of the aerodynamic side skirt system 12 illustrated in FIGS. 1 and 2 is shown. Many of the features and components of the embodiment 834 illustrated in FIG. 11 are common to, and a combination of, those illustrated in each of FIGS. 3 and 10, and like features and components are illustrated in FIG. 11 with like numbers offset from FIG. 3 by a factor of 700 and from FIG. 10 by a factor of 100. The embodiment 834 illustrated in FIG. 11 is similar to that illustrated in FIG. 10 in that each flexible panel section 836 includes a pair of tabs 856A and 856B extending laterally away from one side 852 of the flexible panel section 836, such that the tab 856A is juxtaposed over the tab 856B. The embodiment 834 illustrated in FIG. 11 further includes another tab 858, identical to the tabs 856A and 856B, extending laterally away from the opposite side 854 of the flexible panel section 836, such that the resulting tab arrangement resembles that illustrated in FIG. 3. Like the embodiment illustrated in FIG. 3, the tabs 856A, 856B and 858 are positioned relative to the sides 852 and 854 respectively of the flexible panel sections 836 such that the tab 858 extends between the tabs 856A and 856B when opposing ends 852 and 854 of two adjacent flexible panel sections 836 are brought together, and the tabs 856A, 856B and 858 thereby interlock with each other in a manner that aligns the plurality of flexible panel sections 836 transversely such that the plurality of flexible panel sections 836 all lie substantially along a common line that is, or is parallel with, the longitudinal axis defined by the flexible panel member 834. And like the embodiment illustrated in FIGS. 7 and 10, the corrugations defined by the tabs 856A, 856B and 858 provides for lateral movement of the flexible panel sections 836 relative to each other.

In some embodiments, the outermost flat portions of the tabs 856A, 856B and 858 may be affixed to the inner surfaces 836A of the flexible panel sections 836 as described with respect to FIGS. 7-8B, and each of the tabs 856A, 856B and 858 in such embodiments therefore operate as described with respect to FIG. 7. In alternate embodiments, the outermost flat portions of the tabs 856A, 856B and 858 are not affixed to the inner surfaces 836A of the flexible panel sections 836, and in such embodiments the tabs 856A, 856B and 858 operate as described with respect to FIG. 3. It will be understood that while the embodiment 834 illustrated in FIG. 11 is shown with two tabs 856A, 856B extending laterally away from one side 852 of the flexible panel section 836 and one tab 858 extending laterally away from the opposite side 854 of the flexible panel section 836, the flexible panels 836 may alternatively include any number of such tabs extending laterally away from either side thereof.

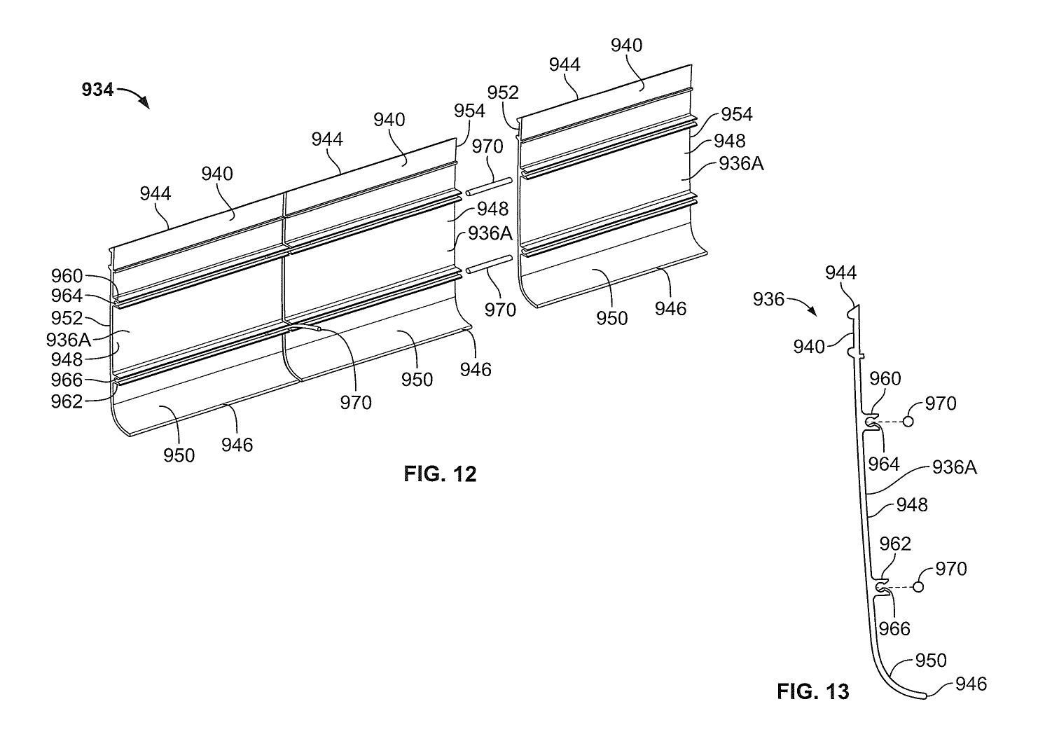

Referring now to FIGS. 12 and 13, yet another embodiment 934 of the flexible panel member 34 forming part of the aerodynamic side skirt system 12 illustrated in FIGS. 1 and 2 is shown. The flexible panel member 934 is illustratively made up of a plurality of flexible panel sections 936, and three complete flexible panel sections 936 are illustrated in FIG. 12. In the illustrated embodiment, each of the plurality of flexible panel sections 936 includes a top section 940 which terminates at a top edge or end 944 of the flexible panel section 936, a bottom section 950 which terminates at a bottom edge or end 946 of the flexible panel section 936 and a middle section 948 which extends between the top and bottom sections 940 and 950 respectively. Each of the plurality of flexible panel sections 936 further defines one side 952 and an opposite side 954 with the top, middle and bottoms sections 940, 948 and 950 respectively extending laterally between the two opposing sides 952, 954.

The inner surface 936A of each of the flexible panel sections 936 defines a pair of connector rails 960 and 962, and the connector rails 960 and 962 each define a longitudinal channel 964 and 966 respectively therein. In the illustrated embodiment, the connector rails 960 and 962 are generally elongated structures that are spaced apart from each other along the inner surfaces 936A of each of the flexible panel sections 936 in a generally parallel configuration. In this embodiment, the channels 964 and 966 extend longitudinally along the corresponding connector rails 960 and 962 respectively. In some alternate embodiments, the connector rails 960 and 962 need not be elongated and/or may each be partitioned into two separate connector rails, each positioned adjacent to an opposite side 952, 954 of the flexible panel section 936. In other alternate embodiments, one or more of the flexible panel sections 936 may include more or fewer such connector rails. In one embodiment, the connector rails 960 and 962 are integral with the inner surface 936A of each of the flexible panel sections 936, although in alternate embodiments the connector rail 960 and/or the connector rail 962 may be separate from the inner surface 936A and affixed thereto using one or more conventional attachment structures and/or techniques.

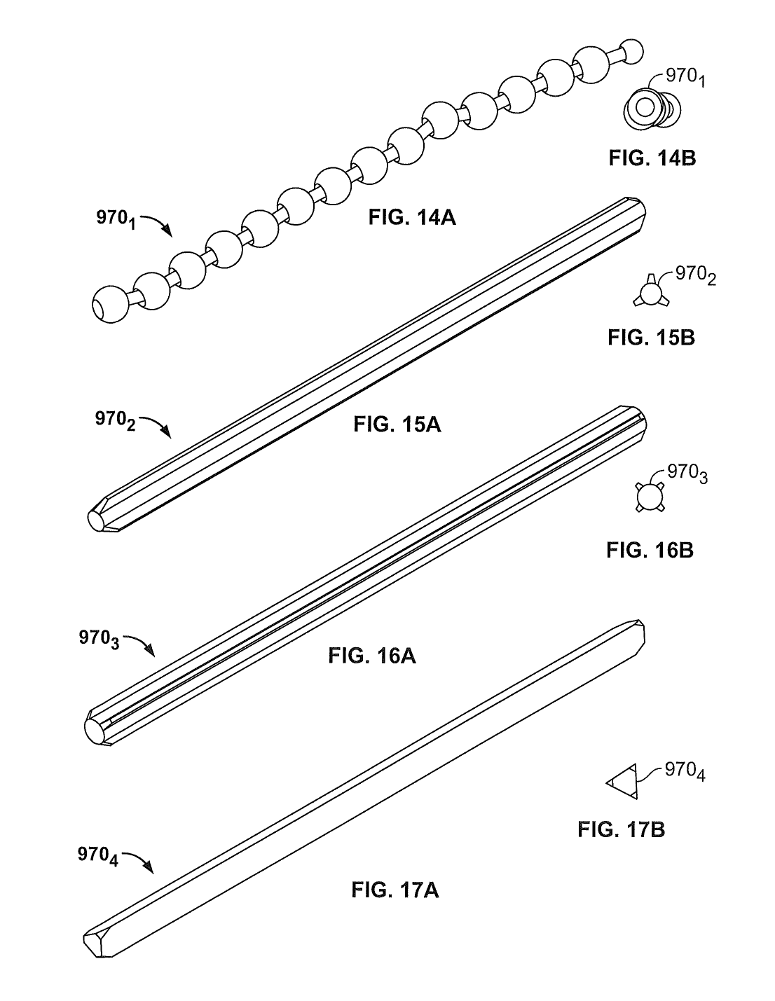

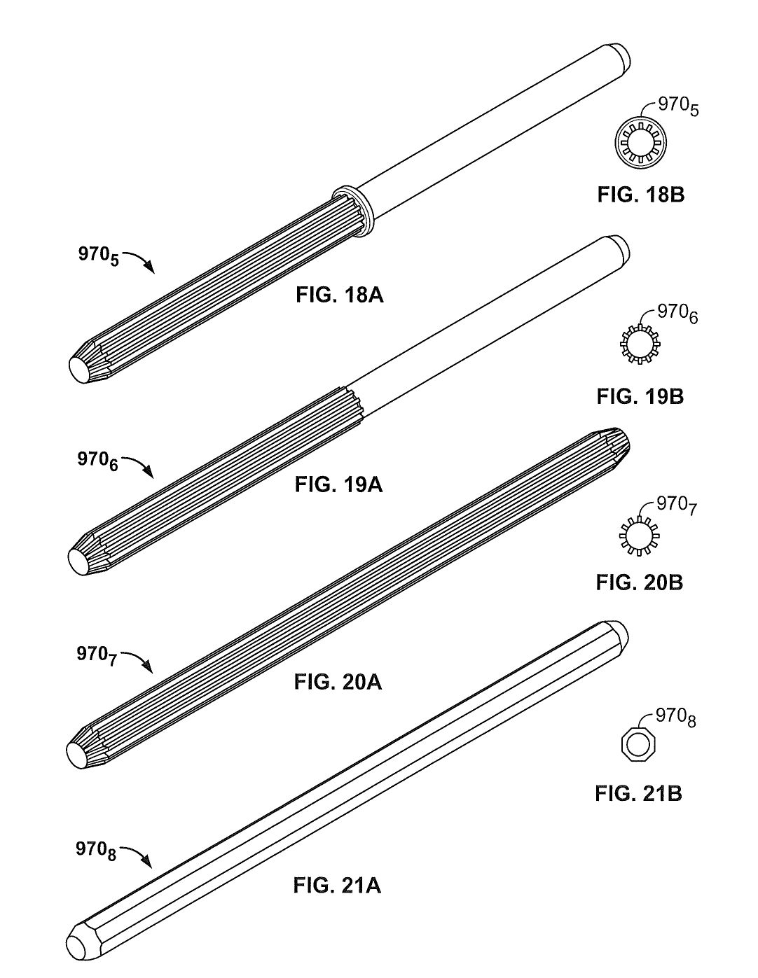

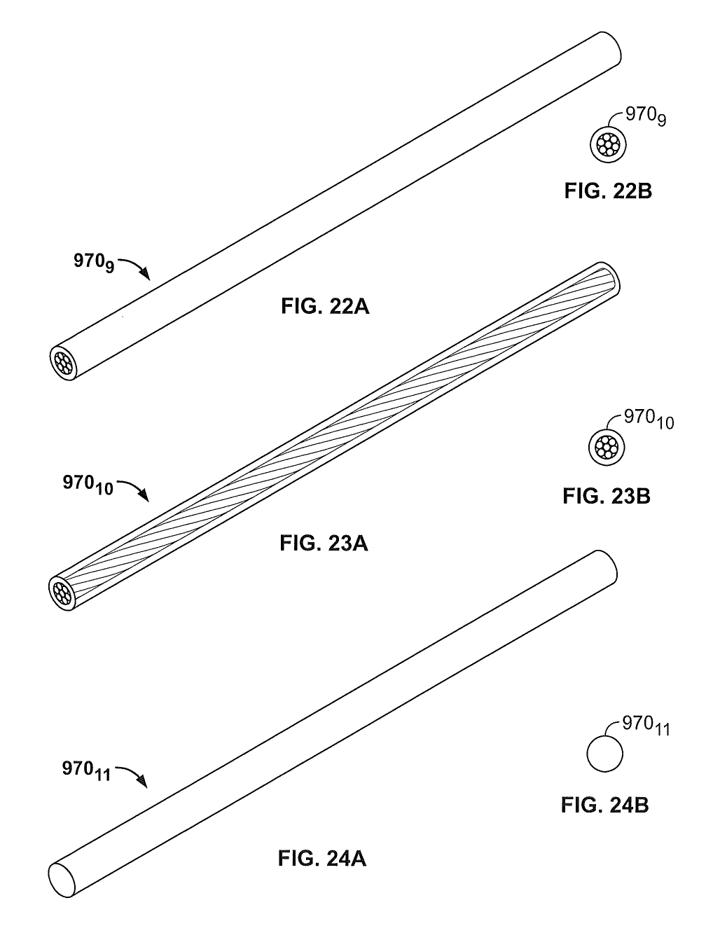

A connector element 970 is positioned within and retained by each of the channels 964 and 966 of adjacent ones of the flexible panel sections 936 as illustrated in FIG. 12 to thereby connect adjacent flexible panel sections 936 together. The channels 964, 966 and connector elements 970 are illustratively sized such that the connector elements 970 are movable within and relative to the channels 964, 966 so that adjacent flexible panel sections 936 may move relative to each other, as described hereinabove with respect to the embodiments of FIGS. 3-11, in directions parallel to the longitudinal axes defined by the channels 964, 966. The connector elements 970 may be provided in myriad forms, and examples of some such forms are illustrated in FIGS. 14-24. Referring to FIGS. 14A and 14B, one example embodiment 970₁ of the connector element 970 is provided in the form of a flexible string or cable along which beads or balls are periodically positioned. In FIGS. 15A and 15B, another example embodiment 970₂ of the connector element 970 is provided in the form of an elongated triple-flange rod. In FIGS. 16A and 16B, yet another example embodiment 970₃ of the connector element 970 is provided in the form of an elongated four-sided, e.g., square, rectangle, etc., rod. In FIGS. 17A and 17B, still another example embodiment 970₄ of the connector element 970 is provided in the form of an elongated three-sided, e.g., triangular, rod. In FIGS. 18A and 18B, a further example embodiment 970₅ of the connector element 970 is provided in the form of an elongated rod that is splined or knurled along a portion, e.g., approximately one-half, of its length, smooth along another portion, e.g., approximately one-half, of its length, and defining a collar separating the splined and smooth portions. In FIGS. 19A and 19B, still a further example embodiment 970₆ of the connector element 970 is provided in the form of an elongated rod that is splined or knurled along a portion, e.g., approximately one-half, of its length, and smooth along another portion, e.g., approximately one-half, of its length. In FIGS. 20A and 20B, yet another example embodiment 970₇ of the connector element 970 is provided in the form of an elongated rod that is splined along its length. In FIGS. 21A and 21B, still another example embodiment 970₈ of the connector element 970 is provided in the form of an elongated eight-sided, e.g., octagonal, (or six-sided or hexagonal) rod. In FIGS. 22A and 22B, yet another example embodiment 970₉ of the connector element 970 is provided in the form of an insulated metal wire or an insulated group of metal wires. In FIGS. 23A and 23B, still a further example embodiment 970₁₀ of the connector element 970 is provided in the form of a coated, e.g., plastic, metal cable. In FIGS. 24A and 24B, yet a further example embodiment 970₁₁ of the connector element 970 is provided in the form of an elongated shaft or cylinder formed of one or more of wood, plastic, metal or other suitable material.

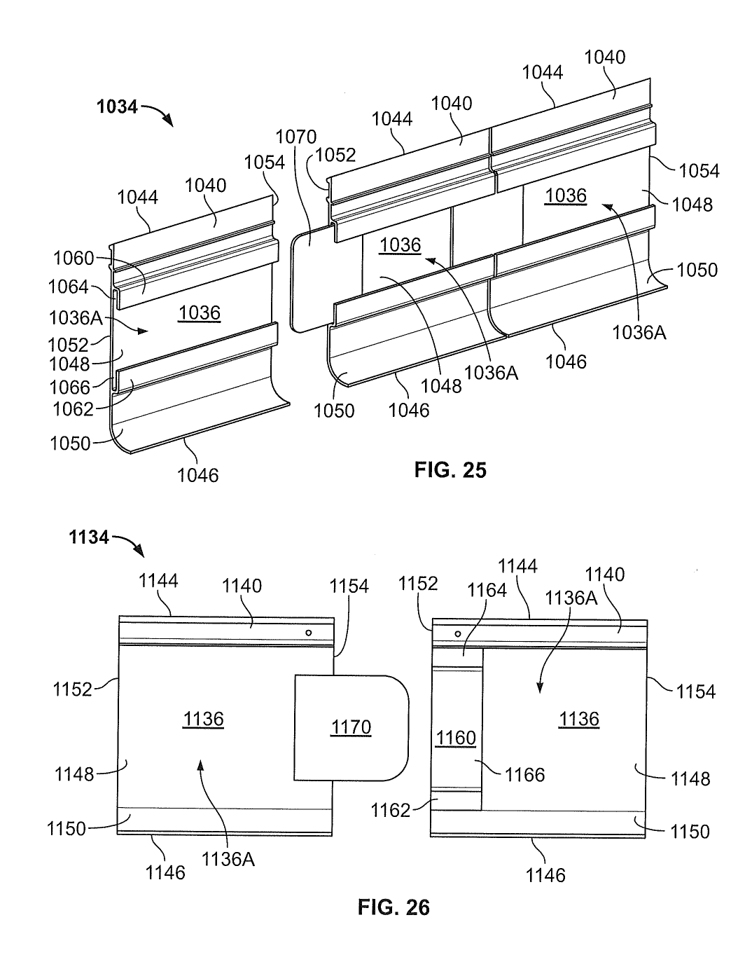

Referring now to FIG. 25, still another embodiment 1034 of the flexible panel member 34 forming part of the aerodynamic side skirt system 12 illustrated in FIGS. 1 and 2 is shown. The flexible panel member 1034 is illustratively made up of a plurality of flexible panel sections 1036, and three complete flexible panel sections 1036 are illustrated in FIG. 25. In the illustrated embodiment, each of the plurality of flexible panel sections 1036 includes a top section 1040 which terminates at a top edge or end 1044 of the flexible panel section 1036, a bottom section 1050 which terminates at a bottom edge or end 1046 of the flexible panel section 1036 and a middle section 1048 which extends between the top and bottom sections 1040 and 1050 respectively. Each of the plurality of flexible panel sections 1036 further defines one side 1052 and an opposite side 1054 with the top, middle and bottoms sections 1040, 1048 and 1050 respectively extending laterally between the two opposing sides 1052, 1054.

The inner surface 1036A of each of the flexible panel sections 936 defines a pair of connector rails 1060 and 1062, and the connector rails 1060 and 1062 each define a longitudinal channel 1064 and 1066 respectively therein. In the illustrated embodiment, the connector rails 1060 and 1062 are generally elongated structures that are spaced apart from each other along the inner surfaces 1036A of each of the flexible panel sections 1036 in a generally parallel configuration. In this embodiment, the channels 1064 and 1066 extend longitudinally along the corresponding connector rails 1060 and 1062 respectively. In some alternate embodiments, the connector rails 1060 and 1062 need not be elongated and/or may each be partitioned into two separate connector rails, each positioned adjacent to an opposite side 1052, 1054 of the flexible panel section 1036. In other alternate embodiments, one or more of the flexible panel sections 1036 may include more or fewer such connector rails. In one embodiment, the connector rails 1060 and 1062 are integral with the inner surface 1036A of each of the flexible panel sections 1036, although in alternate embodiments the connector rail 1060 and/or the connector rail 1062 may be separate from the inner surface 1036A and affixed thereto using one or more conventional attachment structures and/or techniques.

A connector blade or plate 1070 is positioned within and retained by each of the channels 1064 and 1066 of adjacent ones of the flexible panel sections 1036 as illustrated in FIG. 25 to thereby connect adjacent flexible panel sections 1036 together. The channels 1064, 1066 and connector blades or plates 1070 are illustratively sized such that the connector blades or plates 1070 are movable within and relative to the channels 1064, 1066 so that adjacent flexible panel sections 1036 may move relative to each other, as described hereinabove with respect to the embodiments of FIGS. 3-13, in directions parallel to the longitudinal axes defined by the channels 1064, 1066. The connector blades or plates 1070 may be plastic, wood, metal and/or other suitable material.

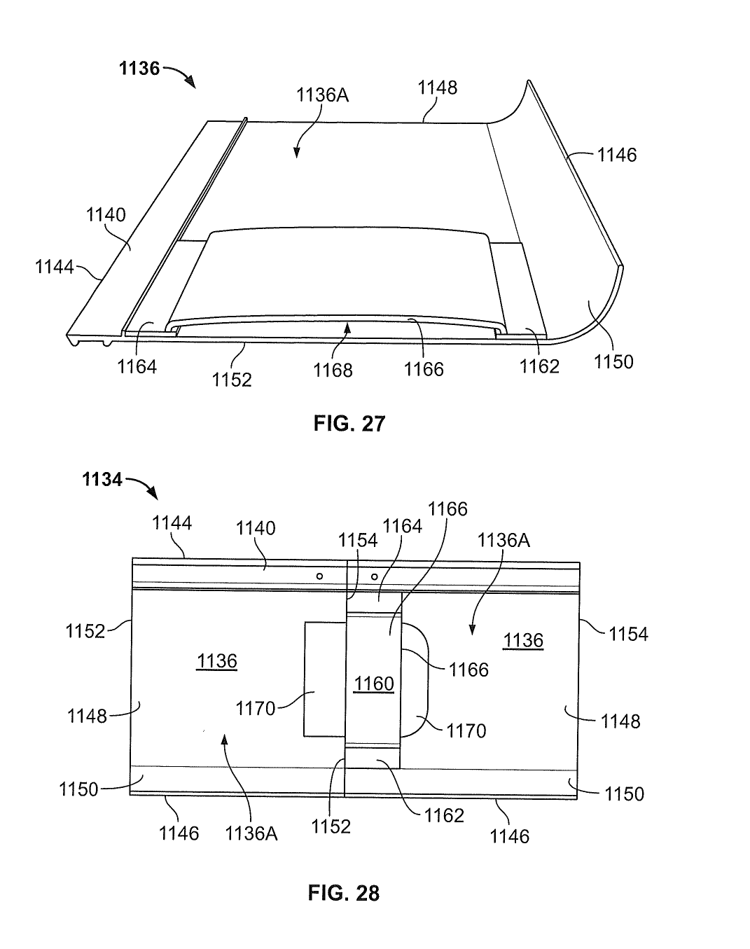

Referring now to FIGS. 26-28, yet another embodiment 1134 of the flexible panel member 34 forming part of the aerodynamic side skirt system 12 illustrated in FIGS. 1 and 2 is shown. The flexible panel member 1134 is illustratively made up of a plurality of flexible panel sections 1136, and two complete flexible panel sections 1136 are illustrated in FIGS. 26 and 28. In the illustrated embodiment, each of the plurality of flexible panel sections 1136 includes a top section 1140 which terminates at a top edge or end 1144 of the flexible panel section 1136, a bottom section 1150 which terminates at a bottom edge or end 1146 of the flexible panel section 1136 and a middle section 1148 which extends between the top and bottom sections 1140 and 1150 respectively. Each of the plurality of flexible panel sections 1136 further defines one side 1152 and an opposite side 1154 with the top, middle and bottoms sections 1140, 1148 and 1150 respectively extending laterally between the two opposing sides 1152, 1154.

The inner surface 1136A of each of the flexible panel sections 1136 defines a slot housing 1160 adjacent to the side 1152, although only one of the flexible panel sections 1136, i.e., the flexible panel section 1136 on the right side of these figures, is shown as including such a slot housing 1160. The inner surface 1136A of each of the flexible panel sections 1136 also defines a tab 1170 extending laterally away from the side 1154, although only one of the flexible panel sections 1136, i.e., the flexible panel section 1136 on the left side of these figures, is shown as including such a tab 1170. In any case, the slot housing 1160 illustratively includes a first rail 1162 defined on the inner surface 1136A of the panel section 1136, a second rail 1164 also defined on the inner surface 1136A of the panel section 1136 and spaced apart from the first rail 1162, and a housing cover 1166 positioned over the inner surface 1136A and affixed to each of the first and second rails 1162, 1164 to define a slot 1168 between the inner surface 1136A of the panel section 1136 and the housing cover 1166. In one embodiment, common ends of the first and second rails 1162, 1164 and of the housing cover 1166 are coterminous with the side 1152 of each panel section 1136, although in alternate embodiments these ends of the first and second rails 1162, 1164 and the housing cover 1166 are coterminous with each other but are recessed inwardly on the panel section 1136 away from the side 1152. The tab 1170 is illustratively defined on the inner surface 1136A of each of the panel sections 1136 near the side 1152, and extends laterally away from the side 1152 of each panel section 1136.

In one embodiment, the tab 1170, the first and second rails 1162, 1164 and the housing cover 1166 are all separate components, and are affixed to the inner surface 1136A of the panel sections 1136 (or, in the case of the housing cover 1160, is affixed to each of the first and second rails 1162, 1164) with one or more conventional fixation elements, e.g., rivets, screws, staples, etc. and/or with a conventional bonding medium, e.g., adhesive or other bonding medium. Alternatively, one or more of the tab 1170, the first and second rails 1162, 1164 and the housing cover 1166 may be formed integrally with the panel sections 1136, e.g., via a conventional molding process, such that the resulting structure is a unitary structure. Alternatively still, while the embodiment 1134 illustrated in FIGS. 26-28 is shown as including only a single tab 1170 and slot 1168, other embodiments are contemplated in which the single tab 1170 and slot 1168 combination may be replaced by multiple tabs and slots on one or both sides of one or more of the panel sections 1136 which make up the flexible panel member 1134.

In any case, the tab 1170 and the slot 1168 defined by the first and second rails 1162, 1164 and the housing cover 1166 are both sized such that the tab 1170 is movably, e.g., slidingly, received within the slot 1168 when two or more of the panel sections 1136 are brought together in side-by-side relationship, and such that the tab 1170 may thereafter move relative to the slot 1168 so that each of the panel sections 1136 of the flexible panel member 1134 are movable relative to each other in a direction parallel to the longitudinal axis of the flexible panel member 1134 as described above with respect to the embodiments illustrated in FIGS. 3-13.

Illustratively, while the flexible panel member 1134 shown in FIGS. 26-28 includes the illustrative flexible panel sections 1136 shown, it should be understood that the flexible panel member 1134 may include other flexible panel sections. For example, the flexible panel member 1134 may include flexible panel sections having a first tab 1170 extending laterally away from the one side 1154 of the flexible panel section as well as a second tab (not shown) extending laterally away from the other side 1152 of the flexible panel section. Further, the flexible panel member 1134 may include a flexible panel section having a slot housing 1160 adjacent each side 1152, 1154 of the flexible panel section. In other words, flexible panel sections may be provided having one tab 1170, one tab 1170 and one slot housing 1160, two tabs 1170, or two slot housings 1160. It is within the scope of this disclosure for the flexible panel member to include any combination of any number of these various interconnecting flexible panel sections.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A flexible panel member coupled to and along a bottom end of a side skirt panel of a trailer side skirt system, the flexible panel member comprising:
a first panel section defining a first side, a second side opposite the first side, and an inner surface therebetween;
a second panel section defining a first side, a second side opposite the first side, and an inner surface therebetween;
a tab extending laterally away from the first side of the first panel section; and
a slot adjacent the second side of the second panel section, wherein the slot is sized and positioned to slidably receive the tab therein when the first and second panel sections are positioned adjacent each other.

2. The flexible panel member of claim 1, wherein the tab is coupled to the first panel section by a rivet, screw, staple, and/or adhesive.

3. The flexible panel member of claim 1, further comprising a housing including a first rail coupled to the inner surface of the second panel section, a second rail spaced-apart from the first rail and coupled to the inner surface of the second panel section, and a housing cover positioned over the inner surface of the second panel section and coupled to each of the first and second rails to define the slot between the inner surface of the second panel section and the housing cover.

4. The flexible panel member of claim 3, wherein the housing is coterminous with the second side of the second panel section.

5. The flexible panel member of claim 1, further comprising (i) a second tab extending laterally away from the second side of the first panel section and (ii) a second slot adjacent the first side of the second panel section.

6. The flexible panel member of claim 1, further comprising (i) a second tab extending laterally away from the first side of the second panel section and (ii) a second slot adjacent the second side of the first panel section.

7. The flexible panel member of claim 1, wherein the tab is configured to move relative to the slot so that each of the first and second panel sections are movable relative to each other in a direction parallel to a longitudinal axis of the flexible panel member.

8. The flexible panel member of claim 1, wherein the tab is integral with the first panel section and the slot is integral with the second panel section.

9. The flexible panel member of claim 1, further comprising a third panel section defining a first side, a second side opposite the first side, and an inner surface therebetween, wherein the second panel section includes a second tab extending laterally away from the first side of the second panel section, wherein the third panel section includes a second slot adjacent the second side of the third panel section, and wherein the second tab is slidably received within the second slot.

10. A flexible panel member coupled to and along a bottom end of a side skirt panel of a trailer side skirt system, the flexible panel member comprising:
a plurality of panel sections each defining a first side, a second side opposite the first side and an inner surface therebetween, and each further defining at least one tab extending laterally away from one of the first side and the second side and at least one corresponding slot at or adjacent to the other of the first side and the second side, the at least one tab and the at least one corresponding slot sized and positioned relative to each of the plurality of panel sections such that the at least one tab of each of the plurality of panel sections is slidably received within the at least one corresponding slot of an adjacent one of the plurality of panel sections when each of the plurality of panels are positioned side-by-side.

11. The flexible panel member of claim 10, wherein the slot of each of the plurality of panel sections is defined between the inner surface of each of the plurality of panel sections and a housing cover positioned over and coupled to the inner surface of each of the plurality of panel sections.

12. A flexible panel member coupled to and along a bottom end of a side skirt panel of a trailer side skirt system, the flexible panel member comprising:
a first panel section defining a first side, a second side opposite the first side of the second panel section and an inner surface therebetween;
a second panel section defining a first side, a second side opposite the first side of the second panel section and an inner surface therebetween; and
a connector engaged with the first and second panel sections, wherein the first and second panel sections are configured to move relative to each other and the connector is configured to slide relative to at least one of the first and second the second panel sections when the first and second panel sections move relative to each other.

13. The flexible panel member of claim 12, wherein the connector is a first tab coupled to and extending laterally away from the first side of the first panel section, wherein the second panel section includes two second tabs coupled to and extending laterally away from the second side of the second panel section, and wherein the first tab is configured to be interlockingly received between the two second tabs when the first side of the first panel section and the second side of the second panel section are adjacent each other.

14. The flexible panel member of claim 13, wherein the first tab is in slidable contact with the inner surface of the second panel section and the two second tabs are each in slidable contact with the inner surface of the first panel section.

15. The flexible panel member of claim 13, wherein the first tab and the two second tabs each define a first flat portion adjacent to a corresponding one of the first and second panel sections, a second flat portion, and a flexible corrugation between and connecting the first and second flat portions.

16. The flexible panel member of claim 15, wherein the second flat portion of the first tab is coupled to the second panel section, and the second flat portion of each of the two second tabs is coupled to the first panel section.

17. The flexible panel member of claim 12, wherein the connector is a tab extending laterally away from the first side of the first panel section, and wherein the second panel section includes a slot configured to slidably receive the tab therein.

18. The flexible panel member of claim 17, further comprising a second tab extending laterally away from the second side of the first panel section, and wherein the second panel section includes a second slot.

19. The flexible panel member of claim 17, further comprising a housing coupled to the inner surface of the second panel section, wherein the housing includes a housing cover positioned over the inner surface of the second panel section to define the slot between the inner surface of the second panel section and the housing cover.

20. The flexible panel member of claim 12, wherein the connector is a flexible rod, wherein the first panel section includes a first connector rail defining a first channel and the second panel section includes a second connector rail defining a second channel aligned with the first channel when the first and second panels are positioned side-by-side, and wherein the connector is slidably received within the first and second channels.
